(19) United States
(12) Patent Application Publication
(10) Pub. No.: US 2005/0165912 A1
(43) Pub. Date: Jul. 28, 2005

(54) GUI-based grid computing data management apparatus method and system

(76) Inventors: Scott Joseph Colbeck, San Jose, CA (US); Vandana Gupta, San Jose, CA (US); Jian Xu, San Jose, CA (US)

Correspondence Address: KUNZLER & ASSOCIATES, 8 EAST BROADWAY, SALT LAKE CITY, UT, 84111, US

(21) Appl. No.: 10/763,528

(22) Filed: Jan. 23, 2004

(51) Int. Cl. G06F 15/16; G06F 17/30; G06F 7/00

(52) U.S. Cl. 709/219; 707/3

(57) ABSTRACT

A replication server accessible via a web browser provides high-level replication services and replication-related services to a user by leveraging low-level file transfer and replica location services associated with a grid. In one embodiment, a set of graphical user interfaces enables a user to edit attributes associated with a data file, replicate a set of data files such as a directory, publish data files to the replica location service, delete one or more data files, search for files with specific attributes, and conduct replication operations on search results. The aforementioned functionality is provided while maintaining the integrity of information maintained by the replica location services.

### BACKGROUND OF THE INVENTION

1. Field of the Invention

The present invention relates generally to data storage and management. Specifically, the invention relates to apparatus, methods, and systems for managing data in a grid computing environment.

2. Description of the Related Art

Recent increases in networking speed, capacity, and usage have facilitated harnessing geographically disperse computing resources to solve computationally complex problems heretofore unsolvable with local computing resources. The ability to harness heterogeneous inter-networked computing resources into a single powerful system has facilitated the development of a new computing paradigm often referred to as ‘grid computing.’ Grid computing enables the virtualization of distributed computing and data resources such as processing power, network bandwidth, and storage capacity to create a single system image that provides users and applications seamless access to vast IT capabilities.

For example, FIG. 1 is a schematic block diagram depicting one embodiment of a typical prior art grid computing environment 100. The depicted grid computing environment 100 includes a number of sites 110, with computing nodes such as workstations 120 and servers 130, interconnected with a local network 140. In the depicted arrangement, each site 110 is connected to an inter-network 160 via one or more inter-site links 150.

Each computing system 120 or 130 within each site 110 may operate as a computing node within the grid. Typically, computing resources that are unused by local users and processes may be offered for use by one or more grid computing tasks. To increase the performance of data access for such tasks, it is often desirable to create local read-only copies (replicas) of data files that may be conveniently accessed during execution. Local replicas of data files may reduce access latency, improve data locality, and/or increase robustness, scalability, and performance of grid-oriented applications.

The process of creating and distributing replicas of data files to multiple local sites creates management issues for users and system administrators. For example, many users throughout a grid may choose to copy data files to a large number of computing nodes throughout the grid. Users may loose track of what files have been replicated and to which locations. Searching throughout the grid to update or delete such files is a very tedious, uncoordinated, and typically error prone process.

FIG. 2 is a block diagram depicting one embodiment of a prior art replication infrastructure 200 that facilitates distributing and tracking replicated files throughout a grid. The depicted replication infrastructure 200 includes local files 210, a file transfer service 220, and a replica location service 230 that uses one or more local replica catalogs 240 and replica location indexes 250. One example of the depicted replication infrastructure 200 is provided by the Globus Toolkit™ created in conjunction with the Open Grid Service Architecture (OGSA) and European DataGrid project.

The file transfer service 220 facilitates the transfer of data files to selected locations on the data grid. Examples of the file transfer service 220 include ftp, http, and grid ftp. The transferred files are typically copied to specific data stores that contain the local files 210 in order to increase data locality and improve performance.

The local replica catalog 240 maps logical file names to physical file names. In one embodiment, a logical file name is a unique logical identifier for desired data content and the physical file name is a unique URL that specifies the data's location on a storage system. The use of logical file names facilitates system-independent and grid-independent programming and execution.

The local replica catalog 240 typically contains mappings for data file replicas that are locally accessible on one or more data stores associated within a site 110 or similar geographical unit. The local replica catalog 240 may also store user-specified attributes associated with a file. The replica location index 250 indicates which local replica catalogs 240 contain mappings for specific logical file names.

The replica location service 230 manages the replica location indexes 250 and the local replica catalogs 240 and facilitates access to the information contained therein via a an application programming interface (API). In one embodiment, multiple replica location indexes 250 may be linked via the replica location service 230 in order that logical file names that are not found within one replica location index 250 may be found in a linked replica location index 250.

The replica location service 230 facilitates managing and tracking local replicas. However, the functionality provided by the replica location service 230 is fairly primitive. For example, the replica location service 230 typically manages index and catalog entries one file at a time, and may not guarantee consistency between data replicas or the uniqueness of filenames. Additionally, the location services provided by the replica location service 230 are not integrated with file-oriented services such as the file transfer services 230 and file-oriented system calls.

A need exists for means and methods that provide higher-level replica management than currently available solutions. Specifically, what is needed are apparatus, methods and systems that facilitate conducting replication operations including directory-based replication operations and other replication-related operations from a remote location in a coherent manner via a user-friendly graphical interface.

### SUMMARY OF THE INVENTION

The present invention has been developed in response to the present state of the art, and in particular, in response to the problems and needs in the art that have not yet been fully solved by grid computing data management systems. Accordingly, the present invention has been developed to provide an apparatus, method, and system for managing data in a grid computing environment that overcome many or all of the above-discussed shortcomings in the art.

In one aspect of the present invention, an apparatus for managing data in a grid computing environment includes a GUI generation module and a replication management module. The replication management module invokes generation of one or more graphical user interfaces by the GUI generation module and conducts data replication operations including directory-based replication operations in response to user selections via the graphical user interfaces. In certain embodiments, the generated graphical user interfaces are web pages. In one embodiment, a sequence of graphical user interfaces is presented in the form of a wizard.

In addition to replication operations, such as replicating an entire directory, the replication management module may also conduct replication-related operations such as publishing data files to a local replica catalog, deleting files, and changing file attributes. In order to conduct the requested operations, the data replication module may invoke a replica location service associated with the grid and one or more file transfer services such as ftp, grid ftp, http, rft, and file. In one embodiment, the replica location service is configured to access at least one replica location index and a local replica catalog.

In certain embodiments, the user may associated attributes or features with data replicas and may initiate searches within the local replica catalogs for files having specific attributes or features. For example, in one embodiment searches may be conducted on logical file names, physical file names, or attributes, and the search queries may include wildcard characters within filename or attribute specifiers. In some embodiments, replication operations and replication-related operations may be conducted on search results.

In another aspect of the invention, a method for managing data in a grid computing environment includes providing a graphical user interface such as a web page that facilitates invocation of data replication operations by a user including directory-based replication operations. The method may also include invoking a replica location service associated with a grid, and conducting the data replication operations in response to selections on the graphical user interface by the user.

In addition to the aforementioned elements, the method for managing data in a grid computing environment may also include accessing a replica location index, accessing one or more local replica catalogs, and invoking a file transfer service. In certain embodiments, the replication operations may be conducted on catalog search results such as files with specific attributes. Replication-related operations may also be conducted such as publishing a set of files to a replica location index and one or more local replica catalogs.

In another aspect of the present invention, a system for managing data in a grid computing environment includes one or more computing nodes with a replica location index stored thereon. The replica location index maps logical names to specific local replica catalogs. The system also includes a replication server that generates one or more graphical user interfaces and conducts data replication operations including directory-based replication operations in response to user selections on the graphical user interfaces.

In addition to the aforementioned duties the replication server may also be configured to conduct publishing operations, replication operations on search results, attribute editing, and searching including attribute-based searches. The system may also include one or more computing nodes having a local replica catalog stored thereon that maps logical file names to physical file names.

The various elements and aspects of the present invention facilitate conducting high-level replication operations including directory-based replication operations and other replication-related operations in a user-friendly manner that maintains the integrity of replica indexes and catalogs with replicated files locally accessible to a computing node. These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram depicting one embodiment of a typical prior art grid computing environment wherein the present invention may be deployed;

FIG. 2 is a block diagram depicting one embodiment of a prior art replication infrastructure suitable for use with the present invention;

FIG. 3 is a schematic block diagram depicting one embodiment of a replication server of the present invention integrated with a prior art grid computing environment and replication infrastructure;

FIG. 4 is a flowchart diagram depicting one embodiment of a replication method of the present invention;

FIG. 5 is a flowchart diagram depicting one embodiment of a replica search method of the present invention; and

FIG. 6 is a flowchart diagram depicting one embodiment of a replica delete method of the present invention.

### DETAILED DESCRIPTION OF THE INVENTION

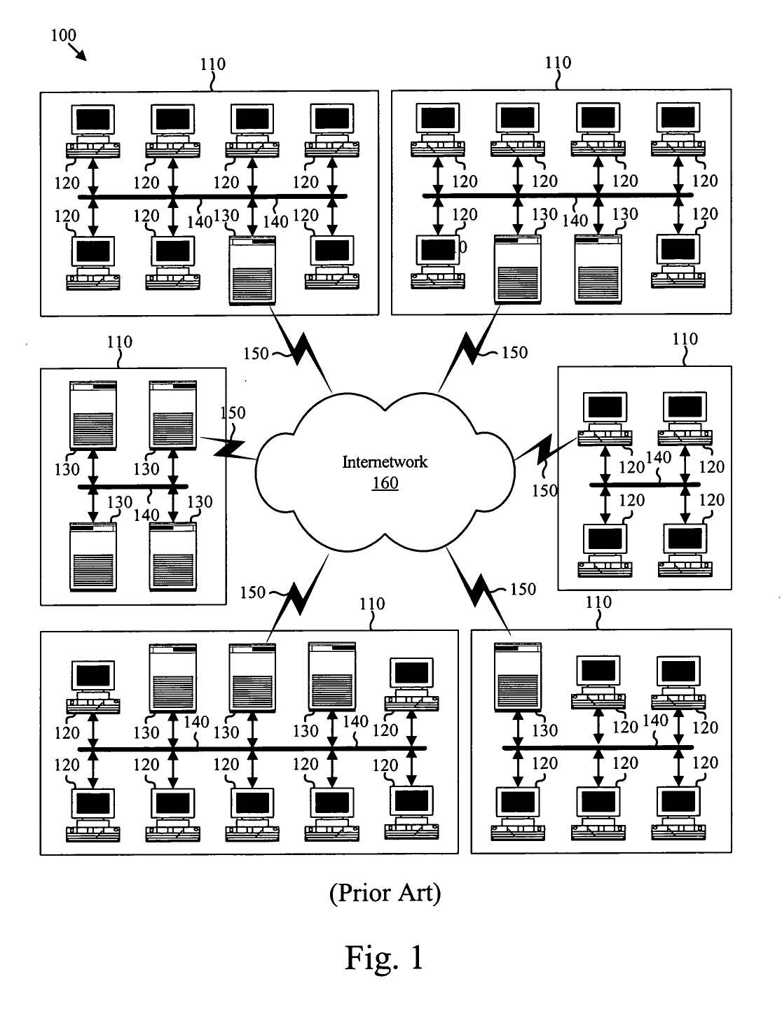

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 1 through 6, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment and the described features, structures, or characteristics may be combined in any suitable manner in one or more embodiments.

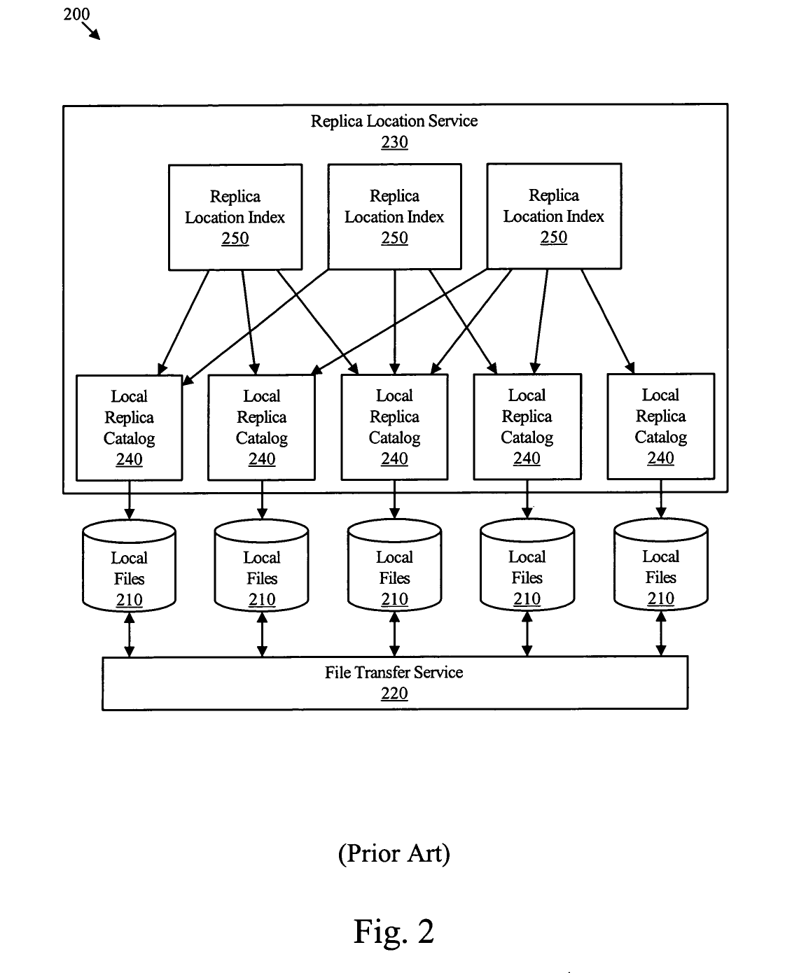

Referring again to FIGS. 1 and 2, the present invention may be deployed in a networked or inter-networked environment such as the grid computing environment 100 depicted in FIG. 1, and may leverage the replication infrastructure 200 depicted in FIG. 2, to provide high-level replication and replication-related services to a user, system administrator, or the like.

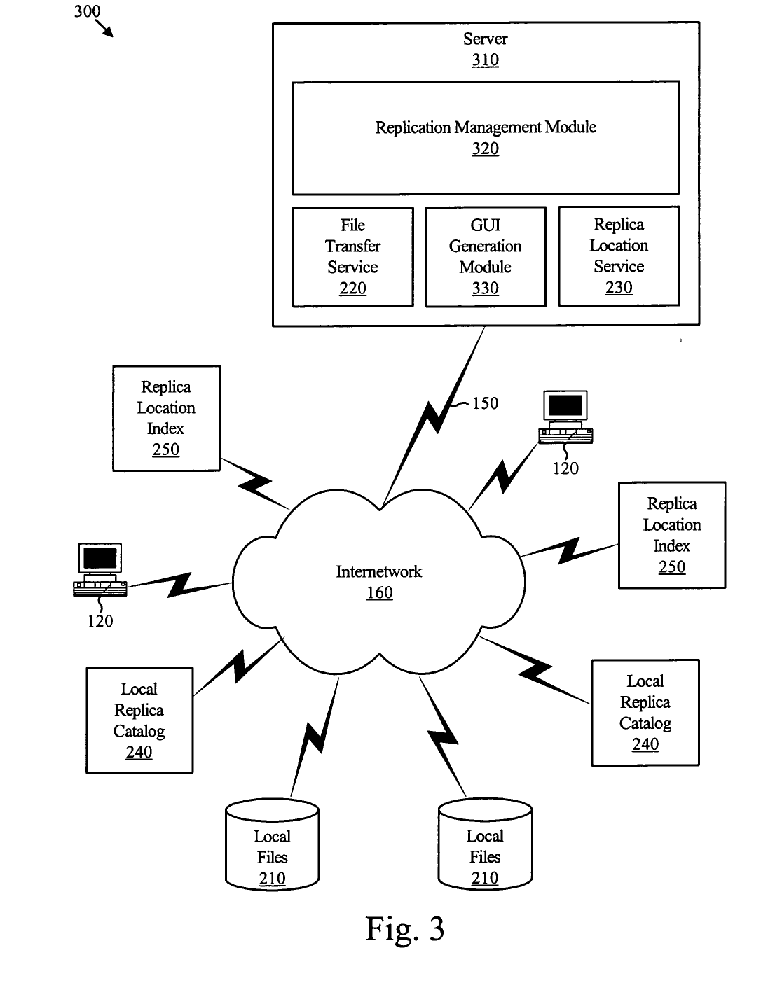

FIG. 3 is a schematic block diagram depicting one embodiment of a replication system 300 of the present invention. The depicted replication system 300 includes a replication server 310 as well as components of the grid computing environment 100 and the replication infrastructure 200, such as one or more local replica catalogs 240 and replica location indexes 250. The replication system 300 provides high-level replication functionality to a user positioned at a workstation 120 or the like.

The depicted replication server 310 includes a replication management module 320 and a GUI generation module 330, as well as the file transfer service 220 and the replica location service 230. The replication server 310 conducts data replication operations including directory-based replication operations and replication-related operations as directed by a user via a graphical user interface such as a web page viewed on a workstation 120, or the like.

Under direction of the replication management module 320, the GUI generation module 330 generates the graphical interfaces accessed by the user. The GUI generation modules 330 may generate and combine specific interface elements such as buttons, list boxes, entry fields, and the like, into a graphical interface suitable for harnessing replication and replication-related operations. In one embodiment, the GUI generation module 330 is a presentation module such as the Tivoli™ Presentation Service.

The replication management module 320 invokes generation of the graphical interfaces to the user. The replication management module 320 also executes replication operations and replication-related operations via including directory-based operations in response to user selections on the presented graphical interface(s).

In conjunction with the supported operations, the replication management module 320 may invoke file transfer services via one or more file transfer services 220, and replica location services via the replica location service 230. In one embodiment, multiple file transfer services 220 may be invoked and the particular transfer service used is selectable by the user via a drop-down list (not shown).

Replication-related operations include publishing operations, file deletion operations, attribute editing operations, viewing file properties, and the like. In one embodiment, publishing involves adding entries to a local replica catalog and an associated replica location index for one or more specified files. The replication and replication-related operations conducted by the replication server 310 and associated replication infrastructure facilitate providing high-level data management features to a grid user or system administrator.

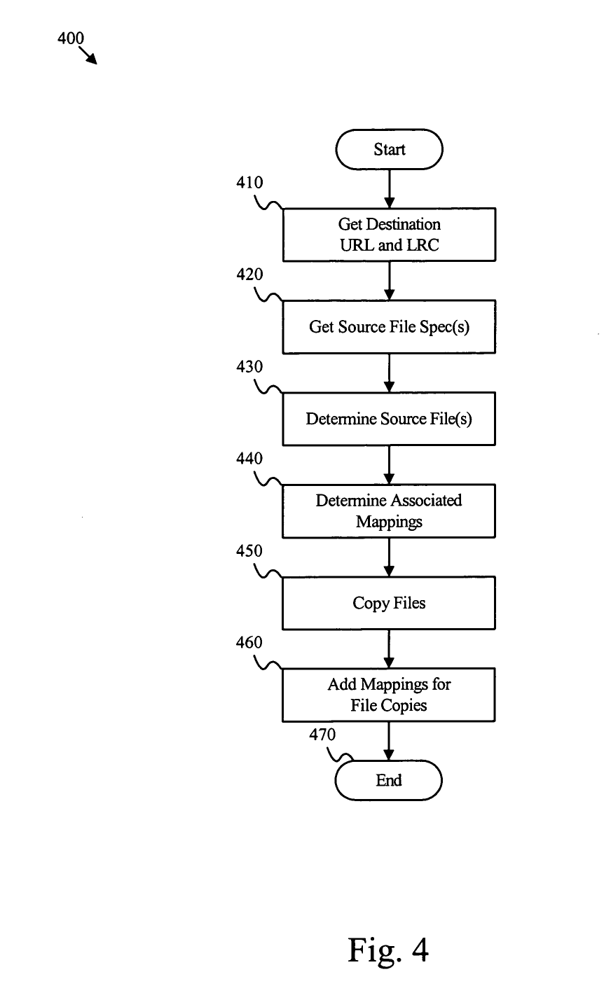

FIGS. 4 through 6 depict specific methods that may be conducted by the replication server 300 to provide high-level user-friendly replication services and replication-related services to a user. The depicted methods are intended to be exemplary of the replication and replication-related functionality that may be provided by the present invention and should not be considered an exhaustive portrayal of such functionality.

FIG. 4 is a flowchart diagram depicting one embodiment of a replication method 400 of the present invention. The replication method 400 includes a get destination step 410, a get source specification step 420, a determine source files step 420, a determine associated mappings step 440, a copy files step 450, and an add mappings step 460. The replication method 400 facilitates replicating one or more files such as an entire directory of files in a convenient manner.

The get destination step 410 retrieves destination information for the invoked replication operation such as a physical filename, and a path for a local resource catalog. In one embodiment, the filename and path correspond to entry fields on a graphical user interface, and the path of the local resource catalog need not be specified if the user does not desire that an entry be placed in the local resource catalog associated with the destination.

The get source specification step 420 retrieves a specification for the source file(s) of the replication operation. In one embodiment, the specification may include wild card characters or directory names. The determine source files step 420 determines the actual source file(s) specified for the replication operation. In one embodiment, determining the source file(s) involves mapping a logical filename to one or more physical filenames.

The determine associated mappings step 440 determines the mappings that are associated with the replication operation in order to retain integrity of the information maintained by the replica location service. For example, replicating a file to multiple destinations requires a mapping for each destination. The copy files step 450 copies the specified source files to the specified destinations, while the add mappings step 460 adds or updates any mappings determined in step 440.

The replication method 400 facilitates providing high-level replication services including directory-base replication services that maintain coherency of the information managed by a replica location service and data files distributed throughout a grid.

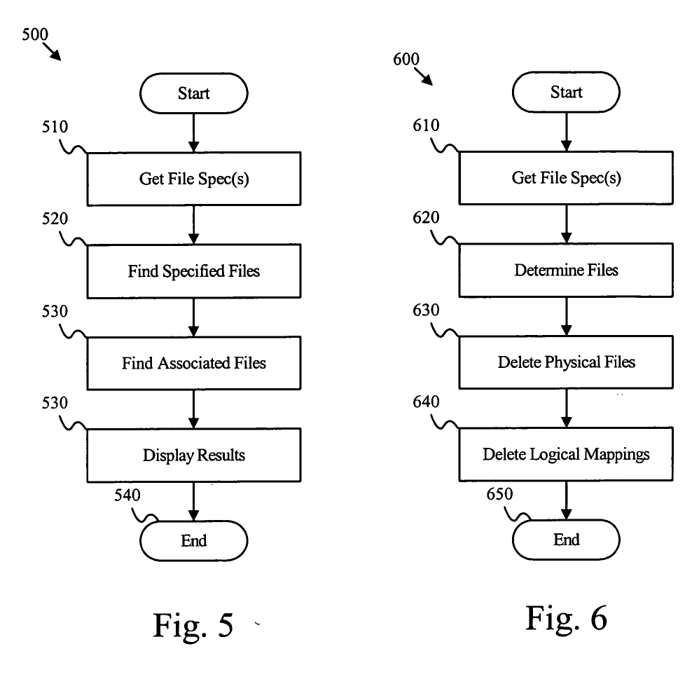

FIG. 5 is a flowchart diagram depicting one embodiment of a replica search method 500 of the present invention. The depicted replica search method 500 includes a get file specifications step 510, a find specified files step 520, a find associated files step 530, and a display search results step 530. The replica search method 500 facilitates locating specific data files associated with a grid.

The get file specifications step 510 retrieves specifications (i.e. search parameters) for files to be located. In one embodiment, the specifications may include attribute values and filenames or directory names including wild card characters. The find specified files step 520 finds the specified files using a replica location service or similar service.

The find associated files step 530 finds files associated with the specified files such as a set of physical files associated with a logical filename or a set of logical filenames associated with a physical file. The associated files may correspond to mappings stored within one or more local replica catalogs. The display results step 540 displays the search results including the specified files and associated files. Upon completion of the display results step 540, the method 500 ends 540.

FIG. 6 is a flowchart diagram depicting one embodiment of a replica delete method 600 of the present invention. The replica delete method 600 includes a get file specifications step 610, a determine files step 620, a delete physical files step 630, and a delete logical mappings step 640. The replica delete method 600 facilitates deleting data files associated with a grid in a convenient manner.

The get file specifications step 610 retrieves specifications for files to be deleted. In one embodiment, the specifications may include filenames or directory names including wild card characters and attribute values. The determine files step 620 determines which physical files conform to the file specifications.

The delete physical files step 630 deletes the determined physical files. In one embodiment, the user is queried to confirm the deletion operation before the files are actually deleted. The delete logical mappings step 640 deletes any logical mappings associated with the physical files from the replica location indexes and local replica catalogs containing mappings for the deleted files. Subsequent to the delete logical mappings step 640, the replica delete method ends 650.

The present invention improves managing local data replicas associated with a grid. As described above, a set of graphical user interfaces generate by a replication server enables a user to edit attributes associated with a data file, replicate a set of data files such as a directory, publish data files to the replica location service, delete one or more data files, search for files with specific attributes, and conduct replication operations on search results.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for managing data in a grid computing environment, the apparatus comprising:
a GUI generation module configured to generate graphical user interfaces;
a replication management module configured to conduct data replication operations including directory-based replication operations; and
the replication management module further configured to invoke generation of at least one graphical user interface, the at least one graphical user interface configured to facilitate invocation of the data replication operations by a user.

2. The apparatus of claim 1, wherein the replication management module is further configured to invoke a replica location service associated with the grid.

3. The apparatus of claim 2, wherein the replica location service is configured to access at least one replica location index.

4. The apparatus of claim 2, wherein the replica location service is configured to access at least one local replica catalog.

5. The apparatus of claim 1, wherein the replication management module is further configured to invoke a file transfer service.

6. The apparatus of claim 5, wherein the file transfer service is selected from the group consisting of ftp, grid ftp, http, rft, and file.

7. The apparatus of claim 1, wherein the at least one graphical user interface comprises at least one web page.

8. The apparatus of claim 1, wherein the replication operations are conducted on search results.

9. The apparatus of claim 1, wherein the replication management module is further configured to change attributes associated with a file.

10. The apparatus of claim 1, wherein the replication management module is further configured to conduct publishing operations.

11. A method for managing data in a grid computing environment, the method comprising:
providing a graphical user interface configured to facilitate invocation of data replication operations by a user including directory-based replication operations;
invoking a replica location service associated with a grid; and
conducting the data replication operations in response to selections on the graphical user interface by the user.

12. The method of claim 11, further comprises accessing at least one replica location index.

13. The method of claim 11, further comprises accessing at least one local replica catalog.

14. The method of claim 11, further comprises invoking a file transfer service.

15. The method of claim 11, wherein the at least one graphical user interface comprises at least one web page.

16. A computer readable storage medium comprising computer readable program code for managing data in a grid computing environment, the program code configured to conduct a method comprising:
providing a graphical user interface configured to facilitate invocation of data replication operations by a user including directory-based replication operations;
invoking a replica location service associated with a grid; and
conducting the data replication operations in response to selections on the graphical user interface by the user.

17. The computer readable storage medium of claim 16, wherein the method further comprises accessing at least one replica location index.

18. The computer readable storage medium of claim 16, wherein the method further comprises accessing at least one local replica catalog.

19. The computer readable storage medium of claim 16, wherein the method further comprises invoking a file transfer service.

20. The computer readable storage medium of claim 16, wherein the at least one graphical user interface comprises at least one web page.

21. The computer readable storage medium of claim 16, wherein the replication operations are conducted on catalog search results.

22. The computer readable storage medium of claim 16, wherein the method further comprises changing attributes associated with a file.

23. The computer readable storage medium of claim 16, wherein the method further comprises conducting publishing operations.

24. An apparatus for managing data in a grid computing environment, the apparatus comprising:
means for providing a graphical user interface configured to facilitate invocation of data replication operations by a user including directory-based replication operations;
means for invoking a replica location service associated with the grid; and
means for conducting the data replication operations in response to selections on the graphical user interface by the user.

25. A system for managing data in a grid computing environment, the system comprising:
at least one computing node having a replica location index thereon, the replica location index configured to map logical names to a local replica catalog; and
a replication server configured to generate at least one graphical user interface and conduct data replication operations including directory-based replication operations in response to user selections on the graphical user interface.

26. The system of claim 25, further comprising at least one computing node having a local replica catalog thereon, the local replica catalog configured to map logical names to physical file names.

27. The system of claim 25, wherein the at least one graphical user interface comprises at least one web page.

28. The system of claim 25, wherein the replication server is further configured to conduct publishing operations, conduct replication operations on search results, and change attributes associated with a file.

29. The system of claim 25, wherein the replication server is further configured to invoke a replica location service associated with the grid.

30. The system of claim 25, wherein the replication server is further configured to access at least one replica location index.
